(19) United States
(12) Patent Application Publication
(10) Pub. No.: US 2024/0232753 A1
(43) Pub. Date: Jul. 11, 2024

(54) FACILITY DEVELOPMENT PLANNING AND COST ESTIMATION

(71) Applicant: Schlumberger Technology Corporation, Sugar Land, TX (US)

(72) Inventors: Daniel Colin Nesbitt Lucas-Clements, Abingdon (GB); Ranjit Ramchandra Vhanamane, Abingdon (GB); Nicholas Hudson, Abingdon (GB); Patricia Alejandra Fleitas Calzadilla, Abingdon (GB)

(21) Appl. No.: 18/558,966

(22) PCT Filed: May 5, 2022
(86) PCT No.: PCT/US2022/027895

§ 371 Date: Nov. 3, 2023

Related U.S. Application Data
(60) Provisional application No. 63/201,565, filed on May 5, 2021.

(51) Int. Cl. G06Q 10/0631; G06Q 10/0637; G06Q 10/067; G06Q 10/10

(52) U.S. Cl. CPC G06Q 10/06313; G06Q 10/06375; G06Q 10/067; G06Q 10/103

(57) ABSTRACT

A method includes receiving input data representing element-level parameters of a project, generating normalized data by normalizing the input data to a neutral reference plane, normalizing including normalizing the element-level parameters based on at least one of transport data, location data, installation data, or time data, adding the normalized data to a database of element-level parameter data, and adjusting one or more parameter curves using the database to which the normalized data was added.

### CROSS-REFERENCE TO RELATED APPLICATIONS

This application claims priority to U.S. Provisional Patent Application Ser. No. 63/201,565, which was filed on May 5, 2021, which is incorporated herein by reference in its entirety.

### BACKGROUND

Facility development planning includes evaluating multiple scenarios for a facility and selecting a scenario by assessing trade-offs among multiple factors. In order to compare and evaluate different options, an economic evaluation of a scenario may be performed. Cost estimates are an input into such an evaluation. However, it may be difficult for organizations to collect cost data and ensure that it is available in a form that can be used to quickly define and compare development scenarios, in order to make decisions. For this reason, many companies use commercial cost estimating software to support the early stages of projects.

Organizations may have their own cost data base from historical projects but sharing the information internally or even using the existing information to adjust cost curves for process equipment or packages is a challenge. Equipment costs provided by third-party software are usually empirical correlations, which may not be accurate and may be hard coded, so cost curves are not shared with customers. In addition, if an organization does have its own cost database, the cost curves generally are not adjusted to match historical data. Thus, this type of modification is done manually by applying corresponding normalization factors and setting up the project into design basis context. As a result, it can be difficult and time consuming for an organization to use its own data in combination with external data.

### SUMMARY

Embodiments of the disclosure include a method that includes receiving input data representing element-level parameters of a project, generating normalized data by normalizing the input data to a neutral reference plane, normalizing including normalizing the element-level parameters based on at least one of transport data, location data, installation data, or time data, adding the normalized data to a database of element-level parameter data, and adjusting one or more parameter curves using the database to which the normalized data was added.

Embodiments of the disclosure include a computing system, including one or more processors, and a memory storing instructions that, when executed by at least one of the one or more processors, cause the computing system to perform operations that include receiving input data representing element-level parameters of a project, generating normalized data by normalizing the input data to a neutral reference plane, normalizing including normalizing the element-level parameters based on at least one of transport data, location data, installation data, or time data, adding the normalized data to a database of element-level parameter data, and adjusting one or more parameter curves using the database to which the normalized data was added.

Embodiments of the disclosure include a non-transitory, computer-readable medium storing instructions that, when executed by at least one processor of a computing system, cause the computing system to perform operations that include receiving input data representing element-level parameters of a project, generating normalized data by normalizing the input data to a neutral reference plane, normalizing including normalizing the element-level parameters based on at least one of transport data, location data, installation data, or time data, adding the normalized data to a database of element-level parameter data, and adjusting one or more parameter curves using the database to which the normalized data was added.

Thus, the computing systems and methods disclosed herein are more effective methods for processing collected data that may, for example, correspond facilities development, e.g., economic data. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2A illustrates a schematic view of a facility development planning system, including cost curve estimation, according to an embodiment.

FIG. 2B illustrates a block diagram of a facility development workflow, according to an embodiment.

FIG. 3 illustrates a flowchart of a method for facility development, according to an embodiment.

FIG. 4 illustrates a flowchart of a process for obtaining input data, according to an embodiment.

FIG. 5 illustrates a flowchart of a process for normalizing input data, according to an embodiment.

FIG. 6 illustrates a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

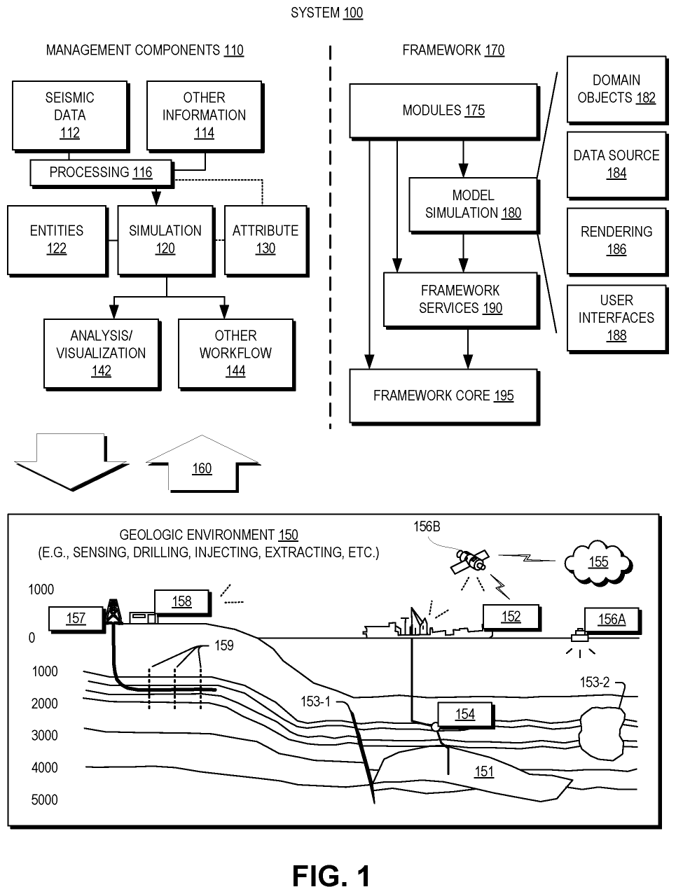

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). The system 100 may also include a framework 170, as discussed below. For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment.

For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of the framework 170, which includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186, and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156A may be located remote from a well site and include sensing, detecting, emitting or other circuitry. Such equipment may include storage and communication circuitry to store and to communicate data, instructions, etc. As an example, one or more satellites 156B may be provided for purposes of communications, data acquisition, etc. For example, FIG. 1 shows a satellite 156B in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workflow may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

Embodiments of the disclosure may provide a computer-implemented method in which the user (e.g., a customer or operator planning a facility) is able to adjust cost curves for equipment, packages, or construction assemblies for facility development planning, using their own data and/or third-party data. In at least some embodiments, the user may also be a vendor or contractor, rather than an operator. Embodiments may also be configured to adjust input costs for equipment, such as labor costs specific to location, and/or activities, such as labor usage, based on historical data. As the term is used herein to describe the embodiments of the systems and methods herein below, “element” refers to anything that is used in a facility that is being developed, and specifically, activities (e.g., labor) and equipment are included in this definition, as well as other costs such as licensing, regulatory fees, etc.

The user can view the cost data and the cost data points and bring them into a data science platform (or “space”) in order to normalize the data points and update the cost curve. Embodiments of the method may include an end-to-end normalization workflow for raw cost data of the facilities. This normalized cost data is used to update the equipment cost curves in facility planner and other applications to generate cognitive insights for the facilities. In addition, embodiments may provide flexibility to the user for making use of their own cost data for future projects and also a more dynamic, transparent and easy methodology to manage and access their historical cost data.

In order to estimate capital costs and operational costs of a development process and production facilities, a cost catalogue may be maintained and accessed. The cost catalogue may be updated and shared transparently with customers. Customers can tune or modify the data as desired. This data collation includes cost data for an equipment or facility package. To obtain the cost catalogue, the raw data may be normalized. The normalized data has many other applications. One such application is to update the cost curve of the equipment in the facility planner. Another such application is the use of normalized data for development of ML (machine learning) applications to generate cognitive insights for customers.

The customer may employ an embodiment of the present disclosure to assess their costs and determine a price to give an operator. Accordingly, in at least some embodiments, the systems and methods could be used in a recursive manner across multiple customers; that is, the system may be used by equipment and/or service vendors to determine the cost of their output, and that output may be evaluated as part of the cost in a facility by another customer, in both cases, potentially employing an embodiment of the present disclosure.

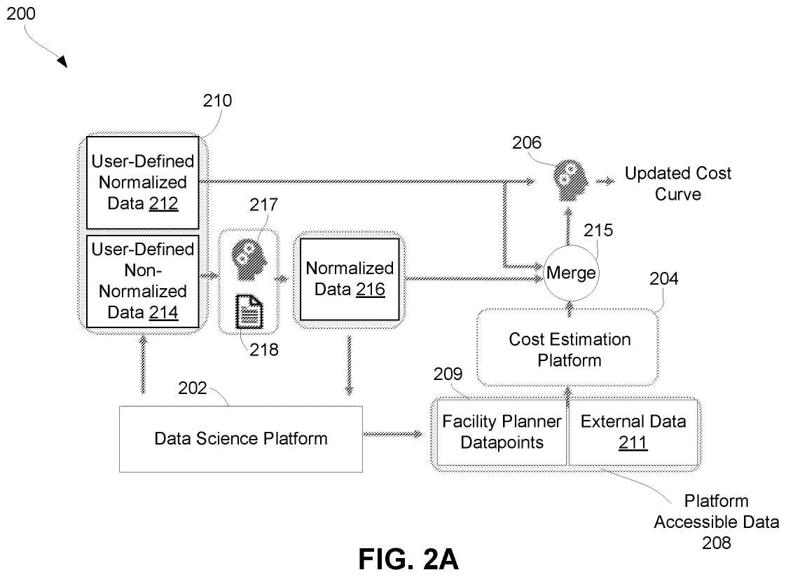

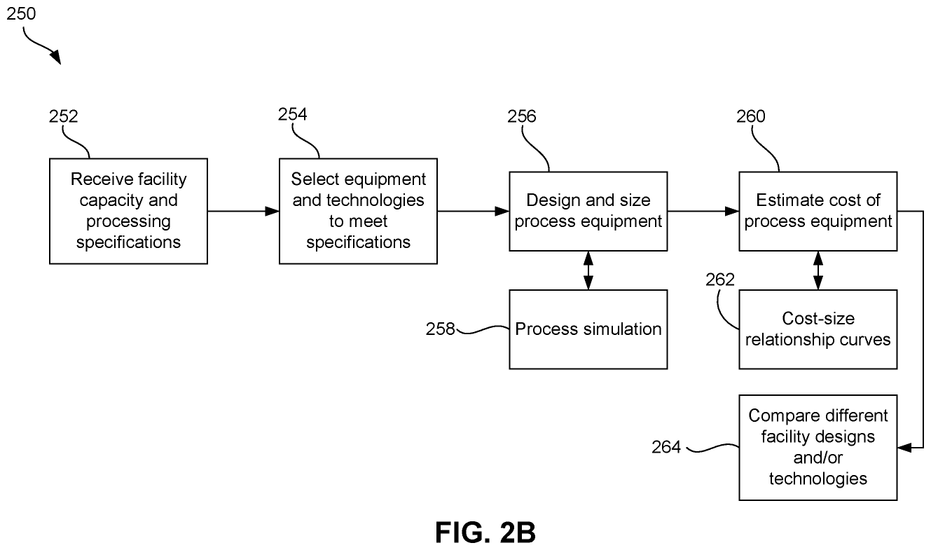

FIG. 2A illustrates a block diagram of a facility development planner 200 that implements a normalization and estimation workflow, according to an embodiment. The facility development planner 200 may be a cloud-based, fast, and collaborative tool for facilities design and cost estimation. The cloud architecture allows new workflows related to parameter (e.g., cost) estimation, which allow curves (e.g., functions relating the parameter value to one or more independent variables) used within facility planner to be extracted (along with technical parameters as context) and modified using a data science application (e.g., DELFI®, commercially available from Schlumberger Technology Corporation). The modification could be done by customer without involving the platform provider, in line with the principle of openness. This approach can be used for capital costs (CAPEX) and operational costs (OPEX) and any other costs associated with the development of process and production facilities.

Further, the facility development planner 200 may be an integrated cloud-based design and collaboration tool for lead facilities engineers, process engineers, and their field development teams to efficiently deliver concept designs that are robust, de-risked, reservoir informed, and demonstrate the value of leading process technologies. It may permit individual contributors to plan their surface facilities with a comprehensive end-to-end facilities design workflow, and to perform sizing and estimate the cost in a real-time cooperative and secure environment. It also may permit comparative evaluation scenarios for different types of reservoir feeds and exports specifications.

The facility development planner 200 may include a data science application or “platform” 202. The data science platform 202 may be configured to store and access databases of information related to projects, e.g., element (activity and/or equipment) costs, locations, normalization factors, time, etc. Further, the data science platform 202 may be configured to interact with users so as to permit input, e.g., of a facility workflow. The data science platform 202 may be configured to execute other applications that support interactive facilities planning in furtherance of such workflows.

The data science platform 202 may be a collaborative platform for data scientists, domain experts, and software developers to develop applications using machine learning and mathematical algorithms. The data science platform 202 may also permit integration of machine learning. For example, virtual agents developed using machine learning algorithms can perform tasks to learn the patterns in the data and form a generalized hypothesis from the data. These tasks can be either perception-based tasks performed using static database such as regression, classification, representation learning etc., or action-based tasks based performed inside dynamic environment such as reinforcement learning where agent has feedback from the environment and can alter the state of the environment based on its actions. Machine learning algorithms also proven to be performing best using structured and unstructured data.

In addition to the data science platform 202, the facility development planner 200 may include a cost estimation platform 204. The cost estimation platform 204 may receive the technological recommendations, and various other inputs, such as location, environmental considerations (e.g., carbon footprint) and/or other factors and an output of the costs associated with such a facility, e.g., from the data science platform 202. In specific embodiments, the data science platform 202 may be configured to receive an indication of throughput desired, a process workflow, equipment listing, etc., and may provide recommendations of technology, equipment size, etc., that permit a facility to accomplish the desired throughput. The cost estimation platform 204 may produce a cost estimation using an engine 206, which may be deterministic or probabilistic, e.g., depending on the input, and provide the cost estimation back to the user. The user can then employ this cost estimation to make decisions related to facilities size, technology, location, etc.

The facility development planner 200 (e.g., the data science platform 202) may be configured to augment platform-accessible data 208 with user-defined data 210. Platform-accessible data 208 may include data stored internally 209, e.g., facility planner data points, and/or external data 211, such as data that is available from other sources, e.g., vendor databases, public databases, etc. The user-defined data 210 may input from a user based on company (e.g., user) specific/proprietary information.

The user-defined data 210 may be provided as user-defined “normalized” input data 212 and/or user-defined non-normalized input data 214. The user-defined normalized input data 212 may augment (e.g., merge with, as at 215) the platform-accessible data 208 without adjustment, or through non-normalizing adjustment such as outlier removal or other statistical processes, for example. In contrast, to permit the user-defined non-normalized input data 214 to be compared with the platform-accessible data 208, the user-defined non-normalized input data 214 is “normalized” to a “neutral reference plane” of the platform-accessible data 208. A normalization engine 217 may utilize a database of normalization factors 218 to implement the normalization process. The normalization engine 217 may thus output normalized data 216, which may be fed to the data sciences platform 202, e.g., long with the normalized user-defined input data 210. The cost estimation platform 204 may merge the normalized user-defined input data 210, the normalized data 216, and the platform-accessible data 208, in order to perform the cost estimation.

At least some of the platform-accessible data 208 and/or the normalization factors 218 may be stored in off-site (e.g., “remote” or “cloud”) servers that are accessible to the facility development planner 200. Such information may include commodity prices, cost indices, inflation index, equipment price escalation, etc. Further, at least some of the normalization factors may vary by facility type (e.g., platform, central processing facility, Floating Production, Storage, and Offloading (FPSO), etc.). That is, different factors (and thus cost curves) may be applicable for different types of equipment and/or other resources (e.g., bulk resources, labor, construction equipment, vessels, etc.).

The normalization process may normalize for the date (e.g., year) of the non-normalized user-defined data 214, the specification of the equipment, the location of the equipment's manufacture and installation, inflation, and the deconstruction of the data into fundamental equipment items or the activities required to construct and installation of that equipment. As additional data becomes available to as part of the platform-accessible data 208, it too may be normalized, e.g., managed by domain experts on periodic basis inside data science platform 202.

The “neutral reference plane” refers to characteristics of the data related to cost of a given element in terms of time, location, and other factors that tend to cause costs for the same element (labor or equipment) to change, without changing the functionality of the underlying element. “Normalizing” the data refers to adjusting the data to account for such changes, thereby bringing the data from a different reference plane to the neutral reference plane. For example, certain extraneous costs can be removed, while other costs can be adjusted to account for changes in these costs through time, location, or both.

To illustrate one specific example, the neutral reference plane might include a location, such as the Gulf of Mexico. The location may be selected because it is where much of the platform-accessible data 208 was collected, and thus where a large amount of historical data (e.g., cost data) was collected that can be brought to bear without substantial modification. However, the user-defined non-normalized input data 214 may be from another location, e.g., the North Sea. Accordingly, to permit accurate comparisons of cost data, the costs from the North Sea (e.g., shipping/freight costs, personnel costs, equipment/materials sourcing locations, other costs, etc.) may be “converted” to costs in the Gulf of Mexico. This conversion may be implemented using factors that may be empirically determined, for example.

The neutral reference plane may also include a time. Historical data from the user may be from years or decades in the past. At least some of the value in the historical data may be in its ability to permit estimating current costs. Thus, the neutral reference plane may be current day. Accordingly, the old data may be updated as part of a normalizing process to the neutral reference plane by correcting for, among other things, inflation. Other factors may also be considered, such as technological advances that render old technologies obsolete and unavailable, or which reduce the costs at a pace that does not correlate to inflation. Additionally, changes in economic and/or political environment, supply availability, etc., may raise or lower the costs in a certain area from what they were at a certain time, and thus those corrections may likewise be applied to normalize the data to the neutral reference frame and permit a comparison with the platform-accessible data 208. Different types of projects may call for different factors to be considered when bringing a set of data into the neutral reference plane, so as to permit for a meaningful comparison with the platform-accessible data 208.

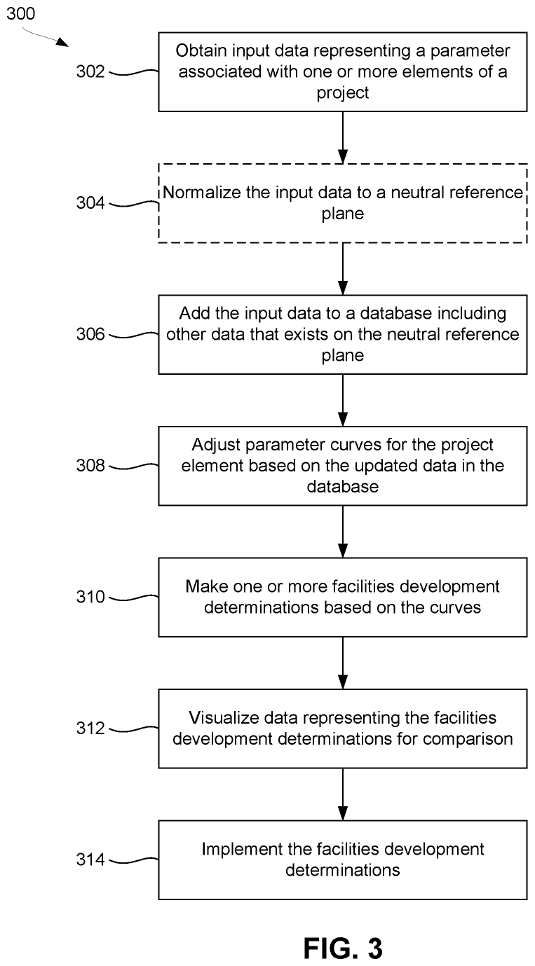

The normalization engine 217 may implement the normalization process using a rules-based algorithm (e.g., considering different factors, as discussed below with reference to FIG. 3) invoked via an application programmer interface (API) and stored inside data sciences platform 202. In other embodiments, a machine learning model may be trained to perform the normalization process, for use separately from the rules-based algorithm or together therewith. The normalized cost data (e.g., the user-defined normalized data 212 and the normalized data 216) points are utilized to update the equipment cost curves through another API function/algorithm. In other embodiments, the updating of the cost curves (including a determination of whether to update the curves based on new data or whether to consider the data unreliable) may be accomplished via a trained machine learning model. This API function and/or machine learning model may update the equipment cost curve parameters from the normalized data points using curve fitting, for example. These normalized cost data points for every equipment in the facility planner can be used to develop machine learning models for predictive analytics or cost forecasting.

Accordingly, in general, embodiments of the present disclosure may permit a user to upload and maintain a database of cost curve information, see the curves as they are generated, and modify the curves. Because of the open/decentralized nature of such embodiments of the present disclosure, the systems and methods herein may be designed to account for different types of unnormalized data, and normalize the data in a robust and automatic manner, e.g., via functions and/or machine learning, permitting, for example, useful comparisons of costs vs. weight, size, etc. for facilities planning. Further, the systems and methods herein may load the normalized data points and compare them to datapoints that were previously received. Curve fittings and other analyses of the new data in combination with the old may then be conducted, in order to produce a more accurate, up-to-date model of the cost projections (e.g., cost-curve). This model may be displayed in various manners and on various different types of displays, consistent with the present disclosure.

FIG. 2B illustrates a block diagram of a facility development workflow 250, according to an embodiment. The workflow 250 may include receiving, e.g., from a user, facility capacity and processing specifications, as at 252. Based on such specifications, the workflow 250 may include selecting (e.g., automatically, from a database) equipment, technologies, labor, etc., to meet the specifications, as at 254. The workflow 250 may further include designing and sizing process equipment, as at 256. As a part of such designing at 256, the workflow 250 may include performing process simulations, as at 258, e.g., to support recommendations related to equipment, labor, and its ability to meet the specifications and cost associated therewith.

The workflow 250 may include estimating the cost of (or another parameter related to) process equipment, as at 260 and described in greater detail below according to an example embodiment. The workflow 250 may receive and/or adjust cost-size (or any parameter to any other characteristic/independent variable) relationship curves, as at 262, as part of the estimation. Further, the workflow 250 may permit the comparison of different facilities designs/technologies, as at 264.

FIG. 3 illustrates a flowchart of a method 300 for facility development, according to an embodiment. The method 300 may be implemented by performing the actions in the order presented here, or in any other order. Further, in some embodiments, two or more of the actions may be combined into a single action, performed in parallel, or performed in sequence, and/or any one of the individual actions may be partitioned into two or more distinct actions.

The method 300 may include obtaining input data representing a parameter associated with one or more elements of a project (“element-level parameters”), as at 302. Illustrative examples of such parameters include costs, time, labor, availability, etc. of a particular element. For purposes of discussed herein, the parameter is generally referred to herein in terms of cost; however, it will be appreciated that the parameter is not limited to costs, but may refer to any other type of parameter, as noted above.

The element-level parameters (e.g., costs) may include labor costs, equipment costs, raw material costs, shipping/installation costs, etc. At least some of the data may be provided on a neutral reference plane. In some embodiments, at least some of the data may be provided on a different reference plane, and may thus not be directly comparable with data that is collected and existing on the neutral reference plane already. As discussed above, the neutral reference plane may be provided for a specific time and place, and thus normalizing the input data to permit a valid comparison to the pre-existing data may include adjusting the input data to the neutral reference plane. In particular, such normalizing may include discounting extraneous data (e.g., factors deemed not relevant to the element-level parameter determination) and/or adjusting or modified values of other data. These modifications, collectively “normalizing”, may permit the generation of an accurate parameter curve, which may permit parameter estimation based on one or more independent variables (e.g., weight, size, speed, etc. of an equipment element).

Accordingly, when non-normalized input data is present in the data obtained at 302, the method 300 may include normalizing at least a portion of the input data to the neutral reference plane, as at 304. Such normalizing may proceed via an algorithm applied by invocation through an API. The normalizing process may include adjusting the non-normalized data such that it represents a value for the parameter that would have been realized if it the project was at different time and location (e.g., that of the neutral reference plane), and with extraneous data removed. The normalizing may include adjusting for time, e.g., based on inflation, technological advancements, raw materials availability/price, political events, etc. The normalizing may also include adjusting for location, e.g., freight expenses, packaging expenses, travel between manufacturing location and operating location, labor costs in different regions, customs expenses, cost impacts of regulatory environments, etc.

Platform-accessible data may be provided in a database, and may be in the neutral reference plane already. Such data may be managed and periodically adjusted to maintain the neutral reference plane, which may change according to changing conditions of the current market. The method 300 may include adding the input data (after normalizing, or without normalizing if it was already in the neutral reference plane) to the database including the other data already existing in the neutral reference plane, as at 306.

For example, a cost estimation platform may adjust one or more parameter (e.g., cost) curves based on the platform-accessible data, as at 308. That is, from the platform-accessible data, which is supplemented with the user-defined data, a statistical determination may be made, associating the parameter (e.g., cost of an element) with one or more independent variables. This may be deterministic or probabilistic. For example, cost as a function of weight may be used for a pressure vessel, or cost as a function of power for a pump or a separator may be provided. Thus, in a facility development application, and continuing with the example of a pressure vessel, given a desired output rate and/or input of raw materials rate, the facility development platform may determine a weight of pressure vessels (e.g., sufficient to handle a certain pressure and volume, with certain properties such as corrosion-resistance, where applicable) to provide such throughput. A cost curve may be calculated that relates the weight to a cost of the pressure vessel, and this may be added to the overall cost of the facility project. Similarly, labor costs may be determined as a function of, for example, cost per man hour, productivity, and/or location, etc. Thus, many cost or other parameter curves may be calculated, for both equipment and labor (collectively considered the “elements” of a project).

Since the database is augmented with the user-defined and normalized data, the curves calculated based on the database may be more closely aligned with the experience of the user. The pre-existing data may provide a greater breadth of experience, e.g., across a wide range of projects. Thus, the combination of the user-defined data and the pre-existing (platform-accessible) data may provide for a more robust set of curves for estimating parameters. These parameters may then be converted to a user's project location, e.g., out of the neutral reference plane. In other embodiments, the neutral reference plane might be the same as the user's project location/time, and thus such adjusting of the parameter estimates outside of the neutral reference plane may not be conducted.

The curves may be used to make one or more facility development determinations, as at 310. Such determinations may include large-scale decisions, such as whether to proceed with a project at all. More granular decisions may also be made, such as adjusting the throughput of the facility, so as to maximize equipment usage and/or reduce costs by eliminating some equipment (which may reduce labor and equipment costs). Further, construction strategies for individual element or the facility may be selected, for example, whether to employ modular construction for an individual element or for many elements so as to enable fabrication work to be carried out off-site, and thereby trade-off duration for cost. Moreover, the type of technology implemented for a given piece of equipment might be adjusted based on parameters such as cost, as well. For example, while an older technology might be less efficient, the differences in cost for the new technology might continue to call for the implementation of the old technology. The location of the facility and/or the source location for equipment, labor, etc. might also be impacted, and a different location may be chosen.

The method 300 may also include displaying or “visualizing” data representing the facility development determinations, e.g., for comparison between different scenarios, as at 312. Accordingly, facility development personnel can quickly observe different options for locations, equipment, etc., and compare parameters and make the aforementioned decisions. Further, the method 300 may include implementing (physically) the facility development determinations, e.g., building the facility, sourcing equipment, sourcing labor, etc., and conducting operations using the facility, as at 314. For example, such determinations may be implemented by selecting a particular type of equipment over another, a manufacturing location, adjusting throughput, etc., and building at least a portion of the facility based at least in part on the determinations.

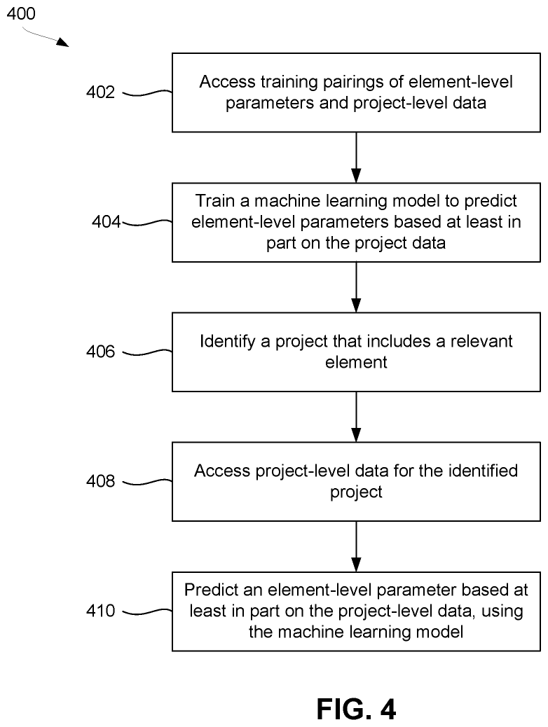

FIG. 4 illustrates a flowchart of a process 400 for obtaining input data, as at 302 of FIG. 3, according to an embodiment. Specifically, in this embodiment of the process 400, a machine learning model is trained and employed to predict element costs (e.g., equipment and/or activity (e.g., labor) costs) from overall project information, including project cost. By predicting the element-level parameters from the “black box” overall data for a project, additional data may be employed to provide more accurate parameter estimation of other projects, as part of the method 300 of FIG. 3. It will be appreciated that machine-learning implementations of obtaining at 302 of FIG. 3 (e.g., using embodiments of the process 400) are merely examples, and the input obtained at 302 of FIG. 3 may be combined or substituted with input of element-level cost data that is not derived from project-level data. Further, the process 400 may be implemented by performing the actions in the order presented here, or in any other order. Further, in some embodiments, two or more of the actions may be combined into a single action, performed in parallel, or performed in sequence, and/or any one of the individual actions may be partitioned into two or more distinct actions.

Referring still to FIG. 4, the process 400 may include accessing training pairs of element-level parameters and project-level data, as at 402. Such accessing may be accomplished by referring to a database of knowledge, e.g., from the vendor, by input from a user, or in any other manner. The data is “paired” in that a link between the project data and the element-level parameter is provided. The project-level data may include data related directly to the element-level parameter (e.g., overall project cost), as well as location, time, company, etc. The element-level data may include the element-level parameter (e.g., element cost), as well as other factors that may impact the parameter value, such as size, labor location/rates, dates, times, etc. Thus, the input data used to train the machine learning model may be robust, including values for multiple different factors that may impact the cost of the element, the project, or both, and which may or may not be applicable to a current project.

The process 400 may also include training a machine learning model to predict element-level parameters based at least in part on the project data, as at 404. As noted above, and continuing with the example of costs, there may be many factors that impact project cost, and thus determining the cost for an individual element of a project, divorced from such factors as shipping, and separated from the costs for other elements that do not impact the cost of the given element, may be a complex activity. However, machine learning models may be well-suited to making predictions based on complex data including such a variety of factors, if sufficient training data is fed thereto. Accordingly, a large number of training pairs, e.g., based on many projects for which element-level and project-level cost information is available to the vendor, may be employed to train such a machine learning model.

Once the machine learning model is trained, the process 400 may identify projects upon which to use the machine learning model, as at 406. In particular, the process 400 may include identifying projects that include elements that are “relevant” to (e.g., included or potentially included in) an instant project, i.e., the project currently being planned or developed. The process 400 may then access the project-level data for the identified project, as at 408. Unlike the training data, at least in some embodiments, the projects identified at 406 may include some element-level data, such as what equipment is included, but may not include, or may be missing at least some, element-level details, such that it is not immediately apparent what the parameter of the individual, “relevant” element was from the overall identified project.

As such, the trained machine learning model may be used to predict the element-level parameter, based at least in part on the project-level data, as at 410. Referring again to FIG. 3, the method 300 of FIG. 3 may proceed, using the predicted element cost as at least a portion of the input data, which may be normalized at 304 of FIG. 304, before a remainder of the method 300 of FIG. 3 is executed.

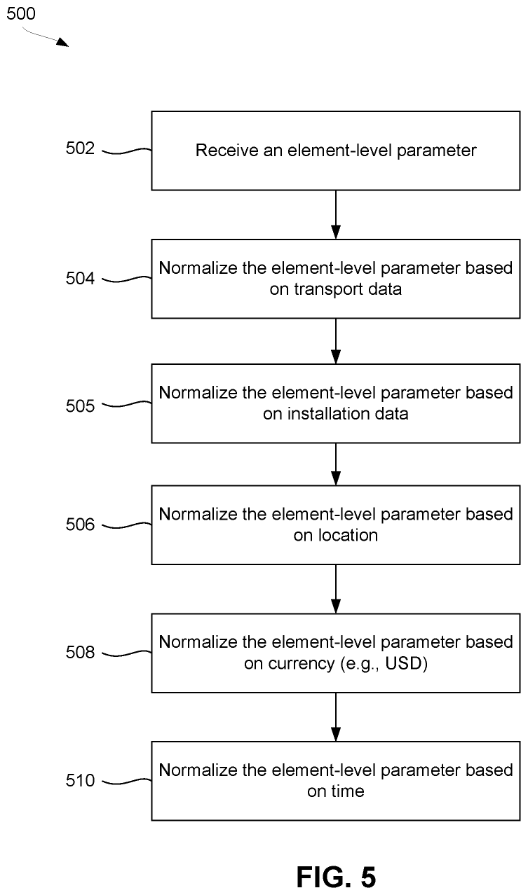

FIG. 5 illustrates a flowchart of a process 500 for normalizing input (e.g., user-defined) data, according to an embodiment. The process 500 may provide an example of the normalizing at 304 of FIG. 3. The process 500 may include receiving an element-level parameter (e.g., cost), as at 502. The element-level parameter may be in a non-neutral reference plan (e.g., time, location, etc. may be different from the neutral reference plane) and may include a variety of factors that may be adjusted or removed in order to place the element-level parameter in the neutral reference plane. Further, the process 500 may be implemented by performing the actions in the order presented here, or in any other order. In some embodiments, two or more of the actions may be combined into a single action, performed in parallel, or performed in sequence, and/or any one of the individual actions may be partitioned into two or more distinct actions.

For example, the process 500 may include normalizing the element-level parameter based on transport data, as at 504. In some embodiments, this may include removing freight, skid/packaging costs, from the cost of the element. In at least some embodiments, the user-defined input data may specify whether it includes freight and/or skid/packaging costs. Further, at least some embodiments may include determining that a manufacturing location of a piece of equipment is different from a delivery location of the piece of equipment, and removing a cost of transport from the manufacturing location to the delivery location from the input data. Accordingly, location-specific information may be removed, such that transport costs may be separately considered, given location-specific costing of such transport.

The process 500 may also include normalizing the element-level parameter based on installation data, as at 505. For example, labor and equipment costs associated with installing equipment may be removed or otherwise adjusted to the neutral reference plane.

The transport parameters and the installation parameters may be normalized at 504 and 505, respectively, based on historical data (e.g., the factors 218 of FIG. 2). For example, historical data may be manually entered or otherwise received from a user. Such costs may be removed because shipping and installation costs may be highly dependent upon location, and thus may be separated out from the element costs and calculated separately based specifically on the location/environment of the project.

The process 500 may also normalize the element-level parameter based on location data, e.g., normalizing manufacturing location to a selected manufacturing location, as at 506. Normalizing based on manufacturing location may include adjusting costs based on labor costs, customs (and/or other regulatory) costs, carbon costs, raw materials, etc. In at least some embodiments, a location factor may be used to convert costs from one location to another. However, for example, manufacturing location might be at least partially a function of operating location, e.g., one manufacturing location might be preferred over another due to proximity. Further, manufacturing location preference might change over time because of political considerations, availability, and/or other aspects not directly related to price. Accordingly, such factors may be removed or adjusted to account for these changes, so as to permit a comparison with the prices of elements from other projects. In at least some embodiments, normalizing equipment costs for manufacturing location considers the likely costs incurred by equipment vendors in manufacturing the equipment and making it available for transport at the operating location of the facility under development (e.g., the factory gate).

The element-level parameter may also be normalized based on currency, as at 508. For example, costs may also be normalized to a selected currency (e.g., US dollars). The element-level parameter may also be normalized based on time, as at 510. For example, historical data may be moved in time to a selected time, such as present day. Such normalizing at 508 and/or 510 may adjust for exchange rates, inflation, technological advancement, changing raw material costs, energy costs, carbon footprint, etc.

Accordingly, in general, embodiments of the present disclosure may permit a user to upload and maintain a database of parameter (e.g., cost) curve information, see the curves as they are generated, and modify the curves. Because of the open/decentralized nature of such embodiments of the present disclosure, the systems and methods herein may be designed to account for different types of unnormalized data, and normalize the data in a robust and automatic manner, e.g., via functions and/or machine learning, permitting, for example, useful comparisons of costs vs. weight, size, etc. for facilities planning. Further, the systems and methods herein may load the normalized data points and compare them to datapoints that were previously received. Curve fittings and other analyses of the new data in combination with the old may then be conducted, in order to produce a more accurate, up-to-date model of the cost projections (e.g., cost-curve). This model may be displayed in various manners and on various different types of displays, consistent with the present disclosure. Further, the model (including facility development decisions made based at least in part on the cost projections) may be physically implemented by one or more users, e.g., to build a facility more efficiently.

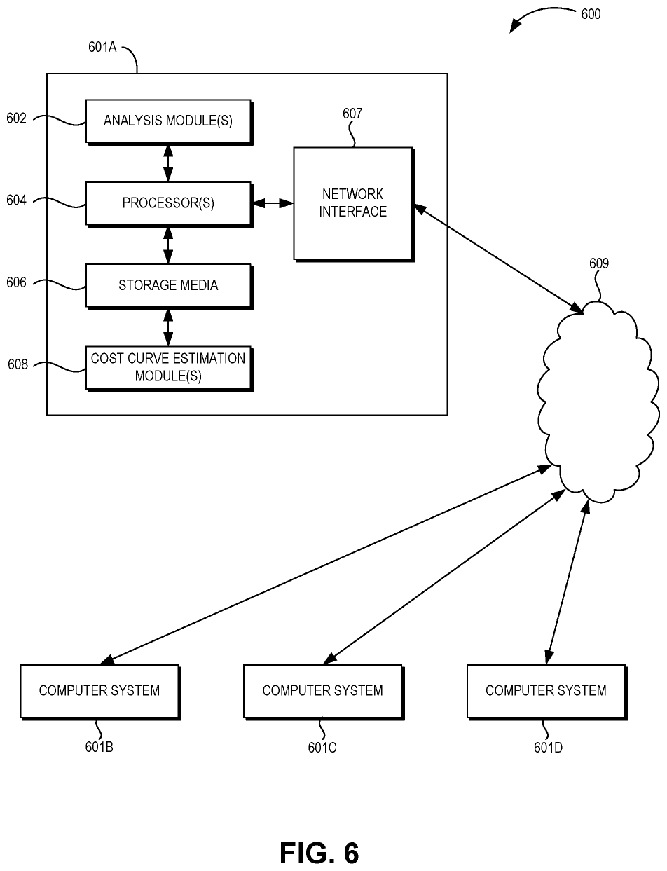

In some embodiments, the methods of the present disclosure may be executed by a computing system. FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor may include a microprocessor, microcontroller, processor module or subsystem, programmable integrated circuit, programmable gate array, or another control or computing device.

The storage media 606 may be implemented as one or more computer-readable or machine-readable storage media. Note that while in the example embodiment of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 600 contains one or more cost curve estimation module(s) 608. In the example of computing system 600, computer system 601A includes the cost curve estimation module 608. In some embodiments, a single cost curve estimation module may be used to perform some aspects of one or more embodiments of the methods disclosed herein. In other embodiments, a plurality of cost curve estimation modules may be used to perform some aspects of methods herein.

It should be appreciated that computing system 600 is merely one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 600, FIG. 6), and/or through manual control by a user who may make determinations regarding whether a given step, action, template, model, or set of curves has become sufficiently accurate for the evaluation of the a facility development plan.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method, comprising:
receiving input data representing element-level parameters of a project;
generating normalized data by normalizing the input data to a neutral reference plane, wherein normalizing includes normalizing the element-level parameters based on at least one of transport data, location data, installation data, or time data;
adding the normalized data to a database of element-level parameter data; and
adjusting one or more parameter curves using the database to which the normalized data was added.

2. The method of claim 1, further comprising receiving user-defined normalized input data representing element-level parameters for the project, wherein adjusting the one or more parameters curves is based at least in part on the user-defined normalized input data.

3. The method of claim 1, further comprising:
training a machine learning model to predict element-level parameters from project-level data;
identifying one or more projects that include a relevant element; and
predicting an element-level parameter associated with the relevant element based on project-level data for the one or more identified projects, using the trained machine learning model,
wherein the one or more parameter curves are adjusted based at least in part on the predicted element-level parameter.

4. The method of claim 1, wherein normalizing includes removing data associated with at least one of freight, packaging weight, or customs-related expenses.

5. The method of claim 4, wherein normalizing comprises:
determining that a manufacturing location of a piece of equipment is different from a delivery location of the piece of equipment;
determining data related to transporting the piece of equipment from the manufacturing location to the delivery location; and
removing the data related to transport from at least one of the element-level parameters.

6. The method of claim 1, wherein normalizing includes normalizing for location by applying a factor representing a difference in operating in a location that is different from a location of the project, converting from one currency to another, transporting to an operating location, or a combination thereof.

7. The method of claim 1, wherein normalizing includes normalizing for time by adjusting for element availability, correcting for inflation, or both.

8. The method of claim 1, further comprising:
making a facility development determination based on the one or more adjusted curves; and
at least one of:
visualizing data representing the facility development determination; or
implementing the facility development determination by building a facility based at least in part on the facility development determination.

9. A computing system, comprising:
one or more processors; and
a memory storing instructions that, when executed by at least one of the one or more processors, cause the computing system to perform operations comprising:
receiving input data representing element-level parameters of a project;
generating normalized data by normalizing the input data to a neutral reference plane, wherein normalizing includes normalizing the element-level parameters based on at least one of transport data, location data, installation data, or time data;
adding the normalized data to a database of element-level parameter data; and
adjusting one or more parameter curves using the database to which the normalized data was added.

10. The computing system of claim 9, wherein the operations further comprise receiving user-defined normalized input data representing element-level parameters for the project, wherein adjusting the one or more parameters curves is based at least in part on the user-defined normalized input data.

11. The computing system of claim 9, wherein the operations further comprise:
training a machine learning model to predict element-level parameters from project-level data;
identifying one or more projects that include a relevant element; and
predicting an element-level parameter associated with the relevant element based on project-level data for the one or more identified projects, using the trained machine learning model,
wherein the one or more parameter curves are adjusted based at least in part on the predicted element-level parameter.

12. The computing system of claim 9, wherein normalizing includes removing data associated with at least one of freight, packaging weight, or customs-related expenses.

13. The computing system of claim 12, wherein normalizing comprises:
determining that a manufacturing location of a piece of equipment is different from a delivery location of the piece of equipment;
determining data related to transporting the piece of equipment from the manufacturing location to the delivery location; and
removing the data related to transport from at least one of the element-level parameters.

14. The computing system of claim 9, wherein normalizing includes normalizing for location by applying a factor representing a difference in operating in a location that is different from a location of the project, converting from one currency to another, transporting to an operating location, or a combination thereof.

15. The computing system of claim 9, wherein normalizing includes normalizing for time by adjusting for element availability, correcting for inflation, or both.

16. The computing system of claim 9, wherein the operations further comprise:
making a facility development determination based on the one or more adjusted parameter curves; and
at least one of:
visualizing data representing the facility development determination; or
implementing the facility development determination by building a facility based at least in part on the facility development determination.

17. A non-transitory, computer-readable medium storing instructions that, when executed by at least one processor of a computing system, cause the computing system to perform operations comprising:
receiving input data representing element-level parameters of a project;
generating normalized data by normalizing the input data to a neutral reference plane, wherein normalizing includes normalizing the element-level parameters based on at least one of transport data, location data, installation data, or time data;
adding the normalized data to a database of element-level parameter data; and
adjusting one or more parameter curves using the database to which the normalized data was added.

18. The non-transitory, computer-readable medium, wherein the operations further comprise receiving user-defined normalized input data representing element-level parameters for the project, wherein adjusting the one or more parameters curves is based at least in part on the user-defined normalized input data.

19. The non-transitory, computer-readable medium of claim 17, wherein the operations further comprise:
training a machine learning model to predict element-level parameters from project-level data;
identifying one or more projects that include a relevant element; and
predicting an element-level parameter associated with the relevant element based on project-level data for the one or more identified projects, using the trained machine learning model,
wherein the one or more parameter curves are adjusted based at least in part on the predicted element-level parameter.

20. The non-transitory, computer-readable medium of claim 17, wherein normalizing includes:
removing data associated with at least one of freight, packaging weight, or customs-related expenses;
determining that a manufacturing location of a piece of equipment is different from a delivery location of the piece of equipment;
removing data associated with transport from the manufacturing location to the delivery location from the input data;
applying a factor representing a difference in operating in a location that is different from a location of the project, converting from one currency to another, transporting to an operating location, or a combination thereof; and
adjusting for element availability, correcting for inflation, or both.
